(19) United States
(12) Patent Application Publication
(10) Pub. No.: US 2014/0048173 A1
(43) Pub. Date: Feb. 20, 2014

(54) FUEL NOZZLE

(71) Applicant: Elaflex Hiby Tanktechnik GmbH & Co. KG, Hamburg (DE)

(72) Inventors: Matthias Fedde, Hamburg (DE); Heinz-Ulrich Meyer, Hamburg (DE)

(73) Assignee: Elaflex Hiby Tanktechnik GmbH & Co. KG, Hamburg (DE)

(21) Appl. No.: 13/941,138

(22) Filed: Jul. 12, 2013

(30) Foreign Application Priority Data
Jul. 20, 2012 (EP) 12177223.0

(51) Int. Cl. B67D 7/54

(52) U.S. Cl. CPC B67D 7/54
USPC 141/311 A; 141/311 R

(57) ABSTRACT

The invention relates to a filling nozzle for dispensing liquid into a tank of a motor vehicle, having an actuating lever for a valve device and having a safety device moveable from a blocking position into an enabling position, wherein, in the blocking position, the valve device is closed regardless of the position of the actuating lever, and in the enabling position, the valve device can be opened by means of the actuating lever. The operative connection between the safety device and valve device is realized without external energy. The invention makes it possible to realize a misfilling inhibitor without external electrical energy, for example, and thus to fit a filling nozzle for urea solution, for example, in the explosion-protected region of a conventional fuel filling pump.

The invention relates to a filling nozzle for dispensing a liquid into a tank of a motor vehicle, having an actuating lever for a valve device and having a safety device arranged downstream of the valve device, which safety device can be moved from a blocking position into an enabling position, wherein, in the blocking position, the valve device is closed regardless of the position of the actuating lever, and in the enabling position, the valve device can be opened by means of the actuating lever, and wherein the operative connection between the safety device and valve device is realized without external energy.

Filling nozzles for refilling tanks of motor vehicles are known for example from EP 2 186 773 A1. Likewise known are filling nozzles with a misfilling inhibitor which is intended to ensure that dispensing of liquid takes place only after the filling nozzle is inserted into a tank provided especially for said liquid. In simple cases, such a misfilling inhibitor may comprise merely different diameters of the outlet pipe of the filling nozzle and of the filler neck of the associated tank, such as is known for example in the case of filling nozzles for gasoline and diesel fuels. A filling nozzle as per the preamble of the main claim is known from GB 2447292 A.

With ever more stringent exhaust gas standards, some motor vehicles require auxiliary fluids which are intended to ensure low-emission combustion and thus reduce the exhaust-gas emissions. Known here in particular is a 32.5% urea solution (known under the trade name AdBlue) which serves for reducing the nitrogen oxide emissions of diesel engines.

Urea solution is already widely used as an auxiliary fluid in the heavy goods vehicle sector, but in the future will also be used for diesel passenger motor vehicles. The significance of a misfilling inhibitor will thus increase if passenger motor vehicles, too, are to have two tanks, one for diesel fuel and one for an auxiliary fluid such as urea solution.

The 32.5% aqueous urea solution used as AdBlue is a highly concentrated salt solution. If drips fall from a filler nozzle for urea solution during the handling thereof, conspicuous salt marks form after the solvent, water, evaporates.

The invention is therefore based on the object of providing a filling nozzle of the type specified in the introduction, which filling nozzle provides the possibility of improved safety against misfilling, and which can be implemented without problems in the filling station environment.

The invention achieves said object in that, in the blocking position, the valve device is closed regardless of the position of the actuating lever, and in the enabling position, the valve device can be opened by means of the actuating lever, and the operative connection between the safety device and valve device is realized without external energy, characterized in that said filling nozzle additionally has a drip prevention valve in the region of the outlet end, which drip prevention valve can be opened by the liquid pressure in the outlet counter to a closing force, and in that the closing force can be varied by the safety device and is greater in the blocking position of the safety device than in the enabling position thereof.

Some expressions used within the context of the invention will firstly be explained.

A filling nozzle is a device for controlling the liquid throughflow during a tank filling process. The demands on the construction and mode of operation of automatic filling nozzles for use on filling pumps are specified in DIN EN 13012 Doc. 2001. Expressions defined therein are also used in the present application.

The feature “for dispensing a liquid into a tank of a motor vehicle” expresses the suitability of the filling nozzle for such a tank filling process.

The actuating lever (also referred to as switching lever) is the apparatus by which the user controls the valve device (also referred to as main valve). The outlet pipe is the apparatus by which the liquid is conducted into the vessel to be filled.

Downstream, that is to say in the flow direction of the liquid between the main valve or the valve device and the outlet end of the outlet pipe, there is arranged a safety device which can be moved from a blocking position into an enabling position. In the blocking position, the valve device is closed regardless of the position of the actuating lever, that is to say no filling process can take place. In the enabling position, the valve device can be actuated in the usual way by means of the actuating lever.

The purpose of said safety device is that it is moved into the enabling position only when the filling nozzle has been inserted into the filler neck of the tank provided for the corresponding liquid, such that misfilling is prevented.

The safety device may be moved manually from the blocking position into the enabling position once the user is certain that the filling nozzle has been inserted into a suitable tank. Alternatively, by means of the design of the filling nozzle and of the associated tank neck, it can be ensured that the safety device is moved automatically from the blocking position into the enabling position as a result of the insertion of the filling nozzle into a suitable filler neck.

The operative connection between the safety device and valve device is realized without external energy. External energy is any form of energy supplied specifically for the operation of the safety device or which is extracted from an energy source arranged in the filling nozzle. The expression “external energy” encompasses in particular electrical energy, that is to say the filling nozzle according to the invention operates without electrical energy and thus requires no external electrical energy supply or internal electrical energy source, for example a battery. The expression “operative connection between the safety device and valve device” denotes the functional actuation/manipulation of the valve device by the safety device such that, in the blocking position of the safety device, no opening of the valve device by means of the actuating lever can take place.

The design of the safety device and of the operative connection thereof to the valve device without external energy, in particular electrical energy, allows the filling nozzle according to the invention to be used in the direct vicinity of other filling nozzles from which fuel is dispensed and which must therefore satisfy special requirements with regard to explosion prevention. For example, the invention allows a filling nozzle for dispensing urea solution to be arranged in the direct vicinity of diesel or gasoline filling nozzles, for example on the same filling pump.

According to the invention, a filling nozzle additionally has a drip prevention valve in the region of the outlet end. Said drip prevention valve prevents any residual amounts of liquid still situated in the outlet pipe from dripping out. The drip prevention valve does not exhibit any dedicated actuation, for example by means of an operative connection to the switching lever, but rather can be opened by the liquid pressure in the outlet counter to a relatively low closing force. Said low closing force is adequate because said drip prevention valve does not exhibit a valve function per se but is rather merely intended to prevent residual amounts in the outlet pipe from emerging or dripping out.

Said closing force can be varied by means of the safety device and is greater in the blocking position of the safety device than in the enabling position thereof. In the blocking position of the safety device, the drip prevention valve thus provides improved protection against inadvertent dripping. It is preferable in this context if the closing force can be varied by magnetic interaction with the safety device. On or in the connection to the drip prevention valve, there may thus likewise be arranged a magnet device which, in the manner described in more detail below, interacts with a magnet device for example on the sliding sleeve of the safety device.

By contrast, filling nozzles known from the prior art which are used for urea solution and which have a corresponding device for preventing against misfilling require electrical energy for sensors which are intended to detect the insertion of the filling nozzle into a special so-called AdBlue tank and thus prevent misfilling. Said filling nozzles must therefore be arranged remote from fuel filling pumps in order to satisfy the explosion prevention requirements. This makes a tank filling process for both diesel and also urea solution very much more cumbersome owing to the additional maneuvering process that is required. For heavy goods vehicles used in the commercial sector, this may be acceptable, but in the passenger motor vehicle sector, such a dual tank filling process, with the vehicle having to be moved in between, would be unacceptable. The invention makes it possible for filling nozzles for urea solution to be combined with those for diesel fuel in close proximity, for example on a single filling pump.

According to the invention, the operative connection between the safety device and valve device is realized preferably mechanically and/or pneumatically. Particularly preferable is a pneumatic operative connection with the aid of the so-called sensor line, as explained in more detail further below.

The safety device is preferably designed for interacting with a filler neck of a tank provided for the corresponding liquid. Said safety device is preferably moved automatically from the blocking position into the enabling position as a result of the insertion of the filling nozzle into the tank filler neck designed for it. After the insertion of the filling nozzle into the corresponding tank filler neck, the tank filling process can thus be commenced by actuation of the actuating lever.

The safety device may for example be provided for interacting with the structural/mechanical form of a corresponding tank filler neck. Urea tanks in motor vehicles generally have a tank filler neck which, even directly in the inlet region, closely surrounds the outlet pipe of the associated filling nozzle. The safety device may for example have an element which is arranged in a displaceable manner in the region of the outlet pipe and which is pushed from the blocking position into the enabling position by the end edge of the tank filler neck, as described in more detail further below.

In a particularly advantageous embodiment of the invention, the operative connection between the safety device and the valve device (main valve) is realized with the aid of the sensor line of the filling nozzle.

Automatic filling nozzles have a safety cut-off device which automatically terminates the tank filling process when the tank is full. For this purpose, the outlet pipe has a so-called sensor line which communicates pneumatically with a triggering device, arranged in the region of the main valve, for said main valve. The details of the configuration of such a safety cut-off are familiar to a person skilled in the art and are disclosed for example in EP 2 386 520 A1. When the liquid surface reaches the end of the outlet pipe, and thus the inlet of the sensor line, during the course of a tank filling process, the pressure conditions in the sensor line change, leading to a triggering and thus a closure of the main valve.

It is now provided according to the invention that the safety device likewise utilizes said sensor line for communication with, or as an operative connection to, the valve device. The safety device closes the sensor line in the blocking position and opens the sensor line in the enabling position. The closure of the sensor line (or of the outlet-side end thereof) simulates, in effect, a full tank and thus a dipping of the outlet pipe into a liquid, such that the valve device is blocked. If the safety device moves into the enabling position, it opens up the sensor line and permits the pneumatic communication thereof with the surroundings of the outlet-side end of the outlet pipe, and thus allows the valve device to be opened by means of the actuating lever. The safety device may, for this purpose, have a sensor line valve for closing the sensor line in the region of the outlet of the filling nozzle.

In one advantageous embodiment of the invention, said sensor line valve may be magnetically actuable. This means that a magnetic force (preferably using a permanent magnet) assists the closing and/or opening of the sensor line valve.

In one preferred embodiment of the invention, there may be arranged, in the region of the outlet, a sliding sleeve which is axially displaceable in relation to the outlet pipe, which sliding sleeve has arranged thereon or connected thereto an operative magnet which interacts with the magnetically actuable sensor line valve. Here, the expression “operative magnet” expresses merely that the magnet is designed for corresponding interaction with and thus operative connection to the sensor line valve. According to the invention, an operative magnet of said type may also be provided on or in the region of the sensor line valve. One or more magnets may be provided either exclusively on the sensor line valve or exclusively in the region of said sliding sleeve, which magnets interact with a magnetizable material of the corresponding counterpart element (sliding sleeve or sensor line valve), such as for example iron or iron alloys. It is however preferable for corresponding magnets to be arranged both on the sliding sleeve and also on the sensor line valve.

It may be provided that the sliding sleeve can be automatically displaced from a blocking position into an enabling position as a result of the insertion of the filling nozzle into a tank filler neck designed for it. Said displacement of the sliding sleeve then effects a magnetic opening of the sensor line valve, such that, after being inserted into the correspondingly designed tank filler neck, the filling nozzle can be opened by means of the actuating lever, and the tank filling process can be commenced.

The filling nozzle according to the invention may additionally have a gas extraction device, such as is known in principle from the prior art. Since ammonia can be formed as a result of the breakdown of urea, such a gas extraction device can contribute to the elimination or reduction of an unpleasant smell during a tank filling process with urea solution.

The invention thus also relates to a filling nozzle according to the invention which is designed for dispensing urea solution.

The invention also relates to a filling pump for the combined dispensing of fuels and urea solution, which filling pump has at least one filling nozzle for dispensing fuel (in particular diesel fuel). According to the invention, said filling pump also has at least one filling nozzle according to the invention for dispensing urea solution. Such a filling pump permits a convenient simultaneous or directly successive tank filling process with fuel, in particular diesel fuel, and urea solution. Maneuvering of the vehicle in between is not necessary. The configuration of the filling nozzle according to the invention for dispensing urea solution without the supply of external energy, in particular electrical energy, allows it to be used in the direct vicinity of a filling pump for dispensing fuels.

An exemplary embodiment of the invention will be described below on the basis of the drawing, in which:

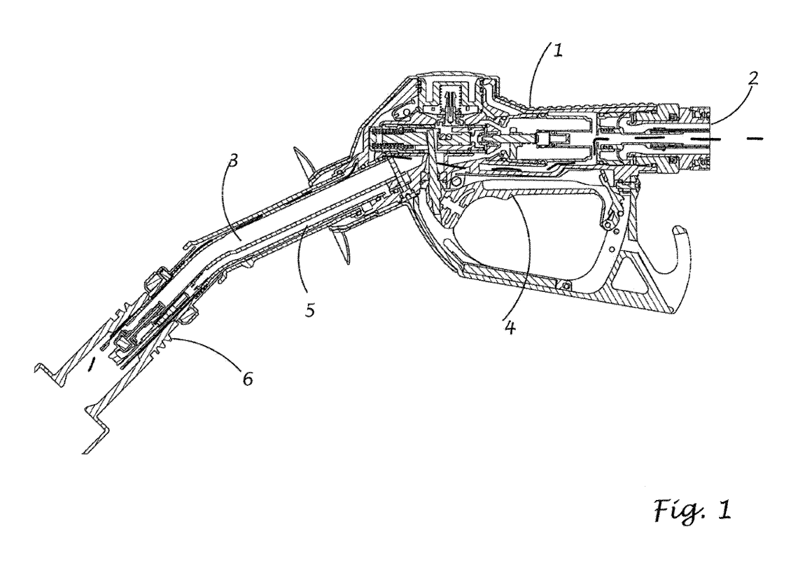

FIG. 1 shows a section through a filling nozzle according to the invention;

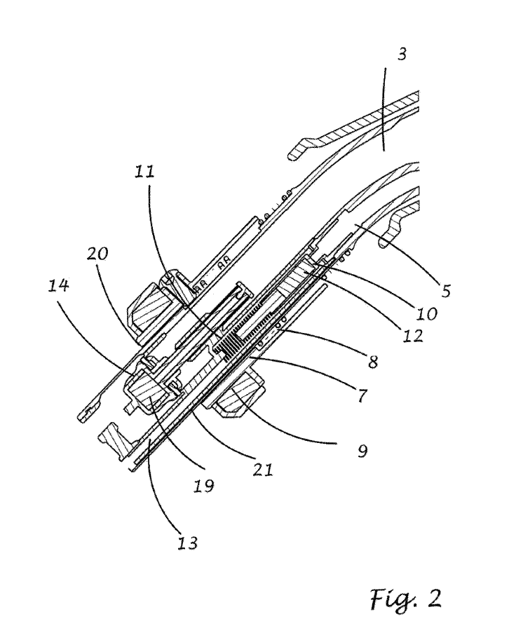

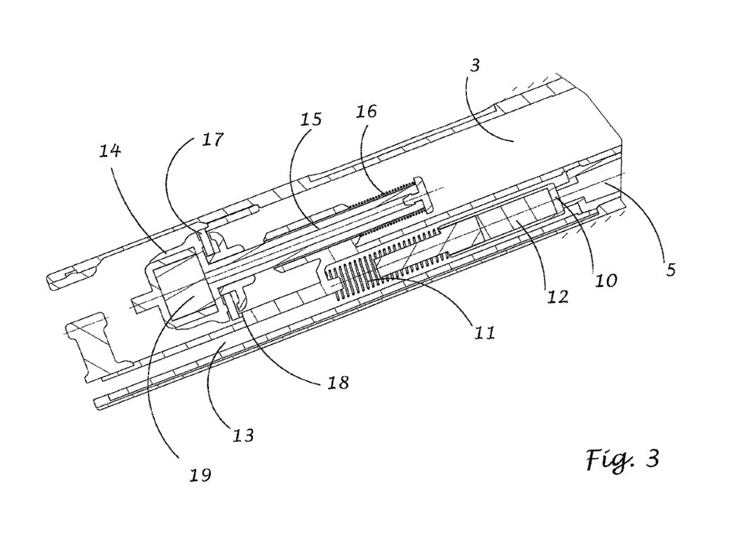

FIGS. 2, 3 show enlarged details from FIG. 1 with the safety device in the blocking position;

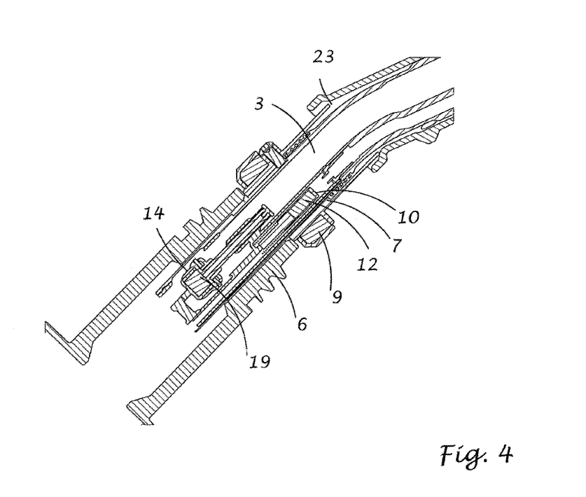

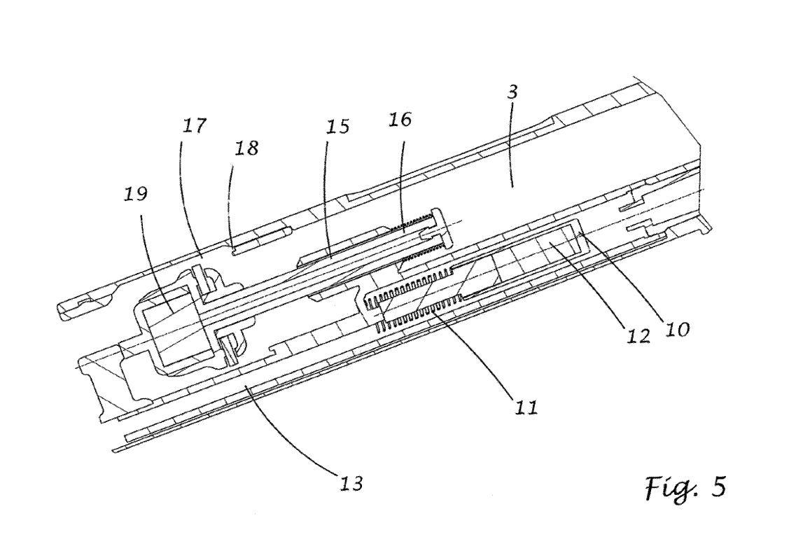

FIGS. 4, 5 show enlarged details from FIG. 1 with the safety device in the enabling position; and

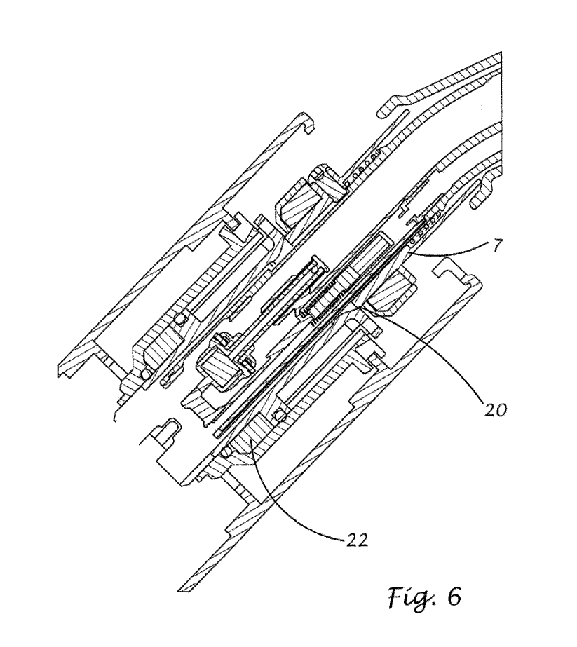

FIGS. 6, 7, 8 show the outlet end of a filling nozzle according to the invention inserted into different tank filler necks.

A filling nozzle (also referred to colloquially as “pistol-grip nozzle”) according to the invention has a valve housing 1, an inlet 2, connected to a hose (not illustrated), for liquid, an outlet pipe 3 and a switching lever 4. In a known manner described for example in EP 2 386 520 A1, the switching lever 4 actuates the valve device or main valve of the filling nozzle. A sensor line 5 communicates pneumatically with the surroundings of the outlet end of the outlet pipe 3, and can thus, in a conventional manner as described in the cited EP document, effect a complete shut-off of the tank.

FIG. 1 shows the outlet end of the outlet pipe 3 inserted into the tank neck 6 of a urea tank of a passenger motor vehicle. Said tank neck is designed so as to closely surround the outlet pipe already directly in the region of the start of the filler neck, as illustrated in FIG. 1.

The design and function of the safety device according to the invention emerge in particular from FIGS. 2-5. A sliding sleeve 7 is arranged around the outer circumference of the outlet pipe 3 in the region of the outlet end. The sliding sleeve 7 is preloaded by a compression spring 8 into the blocking position illustrated in FIG. 2, in which said sliding sleeve is situated in an axial end position in the direction of the outlet end of the outlet pipe 3. An annular operative magnet 9 is arranged on the sliding sleeve 7.

The sensor line 5 is closed off in the region of the outlet end of the outlet pipe 3 by means of a sensor line valve 10 which is preloaded into its closing position by a compression spring 11. The sensor line valve 10 likewise comprises a magnet 12. A sensor line portion 13 extends from the valve seat of the sensor line valve 10 downstream toward the outlet end of the outlet pipe 3, which sensor line portion can communicate with the upstream part of the sensor line 5 when the sensor line valve 10 is open. The expressions upstream and downstream always relate to the flow direction of the liquid in the outlet pipe 3.

A drip prevention valve 14 is also arranged in the region of the outlet end of the outlet pipe 3. On the valve rod 15 there is arranged a compression spring 16 which preloads the drip prevention valve 14 into the closed position with a low force. In said closed position, the valve seal 17 bears against the counterpart surface of the associated valve seat 18, and thus prevents residual amounts of liquid situated in the outlet pipe 3 from dripping out.

In the closed position of the safety device and of the associated sliding sleeve 7 illustrated in FIG. 2, the closing force of the drip prevention valve 14 is intensified by the interaction of the annular magnet 9 of the sliding sleeve 7 with the magnet 19 of the drip prevention valve 14. The magnets 9, 19 attract one another and thus exert an additional closing force on the drip prevention valve 14.

If the filling nozzle according to the invention is inserted into an associated tank filler neck 6, the annular end surface 20 of the sliding sleeve 7 abuts against the corresponding counterpart surface of the tank filler neck 6, and the sliding sleeve 7 is displaced from the blocking position illustrated in FIG. 2 into the enabling position illustrated in FIG. 4, counter to the pressure of the spring 8. In said position, the upstream end of the sliding sleeve 7 abuts against a stop indicated at 23. With the sliding sleeve 7, the operative magnet 9 is also correspondingly axially displaced. As a result of said axial displacement, the operative magnet 9 moves closer to the magnet 12 of the sensor line valve 10 and attracts said magnet 12. As a result of said magnetic force, the sensor line valve 10 is opened counter to the closing force of the spring 11, and assumes the open position illustrated in FIGS. 4 and 5. The sensor line 5 can now communicate with the corresponding portion 13. In said enabling position of the safety device and of the sensor line valve 10, an actuation of the switching lever 4 results in an opening of the main valve, and a commencement of the tank filling process, in the usual way.

As a result of the displacement of the magnet 9 on the sliding sleeve 7 from the blocking position shown in FIG. 2 into the enabling position shown in FIG. 4, said annular magnet 9 moves further away from the magnet 19 of the drip prevention valve 14, such that the closing force of the drip prevention valve 14 decreases and continues to be imparted substantially only by the spring 16. Even a low liquid pressure in the outlet pipe 3 can therefore open the drip prevention valve 14 counter to the force of the spring 16. The tank filling process can be carried out.

The tank filling process can be ended in the usual way by releasing or unlocking the actuating lever 4. If the tank has been substantially filled, the end of the outlet pipe 3, and thus also the portion 13 of the sensor line, dips into liquid. The pressure difference that occurs here pneumatically effects a shut-off of the main valve and thus a termination of the tank filling process, in the conventional manner described in EP 2 386 520 A1.

The tank filling process is likewise ended if the filling nozzle is pulled out of the tank filler neck 6 and the sliding sleeve 7 is displaced from the enabling position of FIG. 4 back into the blocking position of FIG. 2 by means of the spring 8. In this case, the attraction force exerted by the magnet 9 on the magnet 12 of the sensor line valve 10 decreases to such an extent that the spring 11 closes the sensor line valve 10 again. This effects a termination of the tank filling process in the same way as in the case of the outlet pipe 3 dipping into the liquid surface.

Gases escaping during the course of the tank filling process can be returned by the filling nozzle in the conventional manner through a gas extraction duct indicated at 21.

FIG. 6 schematically shows, in a detail, a filling nozzle according to the invention inserted into a conventional tank filler neck of a heavy goods vehicle tank for urea solution. It can be seen that, here, a displacement of the sliding sleeve 7 from the blocking position into the enabling position likewise takes place as a result of an abutment of the end surface 20 of the sliding sleeve 7 against a correspondingly closely configured region of the tank filler neck. In the prior art, heavy goods vehicle tank filler necks for urea solution often have sensor magnets 22 which are intended to interact with a corresponding magnet sensor of a urea filling nozzle of the prior art. Said magnet sensor is generally operated using electrical energy. It can be seen that said magnets 22 are arranged at a considerable distance in particular from the annular magnet 9 and from the magnet 12 of the sensor line valve 10, such that said magnets 22 do not disrupt the corresponding interaction of the annular magnet 9 and magnet 12.

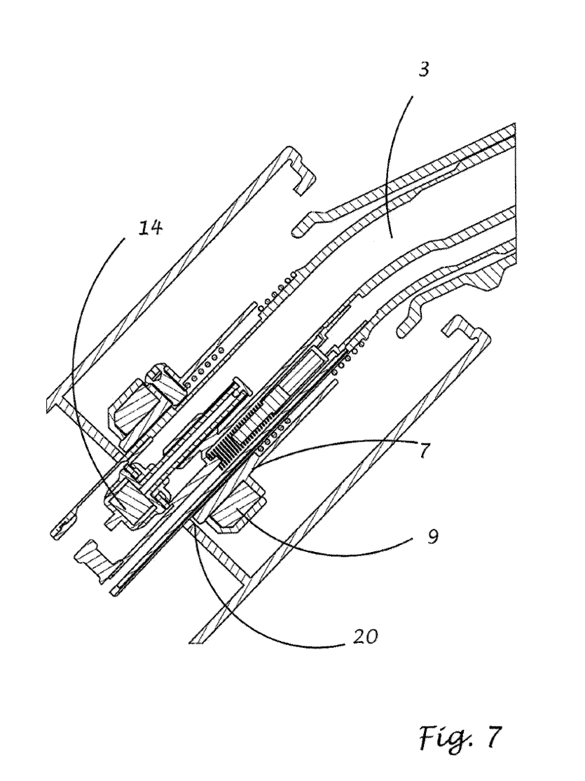

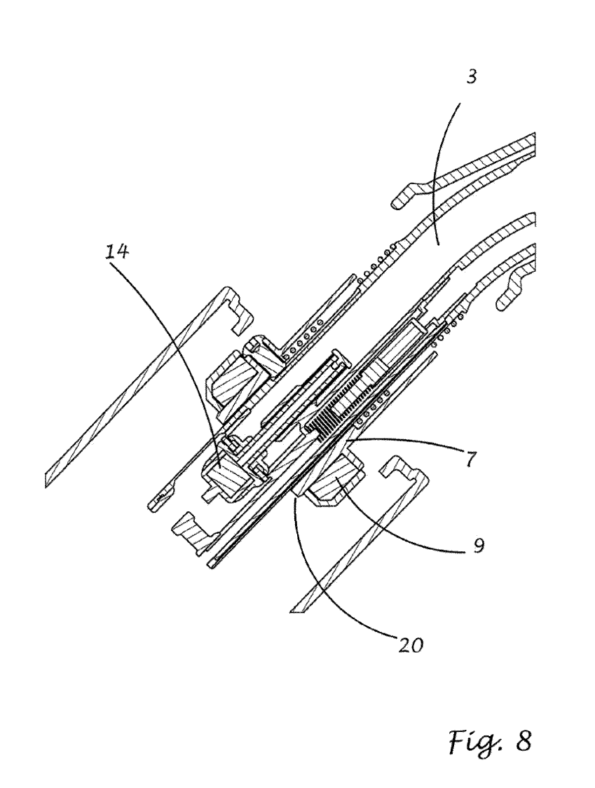

FIGS. 7 and 8 show the situation when a filling nozzle according to the invention is inadvertently inserted into a tank filler neck for unleaded gasoline (FIG. 7) and for diesel fuel (FIG. 8) respectively. In each case, the sliding sleeve 7 remains in the blocking position, such that no tank filling process can be initiated by means of the actuating lever 4.

1. A filling nozzle for dispensing a liquid into a tank of a motor vehicle, said filling nozzle having an actuating lever (4) for a valve device and having a safety device (7, 10) arranged downstream of the valve device, wherein the safety device (7, 10) can be moved from a blocking position into an enabling position,
wherein in the blocking position, the valve device is closed regardless of the position of the actuating lever (4), and in the enabling position, the valve device can be opened by means of the actuating lever (4), and wherein the operative connection between the safety device (7, 10) and valve device is realized without external energy.

2. The filling nozzle of claim 1, wherein the operative connection between the safety device (7, 10) and valve device is realized mechanically and/or pneumatically.

3. The filling nozzle of claim 1, wherein the safety device (7, 10) is designed to interact with a tank filler neck (6), and can be moved from the blocking position into the enabling position as a result of or after the insertion of the filling nozzle into a tank filler neck (6) designed for it.

4. The filling nozzle of claim 1, wherein said filling nozzle has a sensor line (5, 13) for detecting a liquid surface reaching the outlet end of the filling nozzle, and in that the safety device (7, 10) closes the sensor line in the blocking position and opens the sensor line in the enabling position.

5. The filling nozzle of claim 4, wherein the safety device (7, 10) has a sensor line valve (10) for closing the sensor line (5) in the region of the outlet of the filling nozzle.

6. The filling nozzle of claim 5, wherein the sensor line valve (10) is magnetically actuable.

7. The filling nozzle of claim 6, wherein said filling nozzle has, in the region of the outlet, an axially displaceable sliding sleeve (7), wherein on the sliding sleeve (7) there is arranged an operative magnet (9) which interacts with the magnetically actuable sensor line valve (10).

8. The filling nozzle of claim 7, wherein the sliding sleeve (7) can be displaced from a blocking position into an enabling position as a result of the insertion of the filling nozzle into a tank filler neck (6) designed for it.

9. The filling nozzle of claim 1, wherein the closing force of the drip prevention valve (14) can be varied by magnetic interaction with the safety device (7, 10).

10. The filling nozzle of claim 1, wherein said filling nozzle additionally has a gas extraction device (21).

11. The filling nozzle of claim 1, wherein said filling nozzle is designed for dispensing urea solution.

12. A filling pump for the combined dispensing of fuels and urea solution, said filling pump having at least one filling nozzle for dispensing fuel,
wherein said filling pump has at least one filling nozzle according to claim 11 for dispensing urea solution.
